(19) United States
(12) Patent Application Publication
(10) Pub. No.: US 2022/0379628 A1
(43) Pub. Date: Dec. 1, 2022

(54) THERMAL PRINTER

(71) Applicant: HEWLETT-PACKARD DEVELOPMENT COMPANY, L.P., Spring, TX (US)

(72) Inventors: Wesley SCHALK, Vancouver, WA (US); Jay S. GONDEK, Vancouver, WA (US); Jason M. QUINTANA, Vancouver, WA (US); David BUCK, Vancouver, WA (US)

(21) Appl. No.: 17/771,987

(22) PCT Filed: Nov. 26, 2019
(86) PCT No.: PCT/US2019/063346

§ 371 Date: Apr. 26, 2022

(51) Int. Cl. B41J 2/355; B41J 2/525

(52) U.S. Cl. CPC B41J 2/355; B41J 2/525

(57) ABSTRACT

An image forming apparatus comprising a thermal printhead and a controller. The thermal printhead has heating elements. The controller is to receive an indicated print mode corresponding to a type of thermal medium to be used, determine a power profile based on the indicated print mode, and control power to be delivered to the thermal printhead based on the determined power profile.

### BACKGROUND

Printing refers to the formation of text, images, and/or other patterns on a recording medium such as paper. In some examples, a printing compound, such as ink or toner, is deposited on the recording medium in patterns. In other examples, however, no printing compound is used. For example, in thermal printing, a special media referred to as thermal media is used as the recording medium. Thermal media includes a substrate with a material deposited thereon that changes color when exposed to heat. Accordingly, a thermal printing device selectively exposes the thermal media in particular areas that correspond to the text, images, and/or other patterns to print the intended content on the thermal media.

### BRIEF DESCRIPTION OF THE DRAWINGS

FIG. 1 is a block diagram of an image forming apparatus for thermal media printing, according to an example of the principles described herein.

FIG. 2 depicts an image forming apparatus for thermal media printing, according to an example of the principles described herein.

FIG. 3 is a flow chart of a method for thermal media printing, according to an example of the principles described herein.

FIG. 4 is a diagram of print mode selection for thermal media printing, according to an example of the principles described herein.

FIG. 5 depicts the image forming apparatus for thermal media printing, according to another example of the principles described herein.

### DETAILED DESCRIPTION

An “image forming apparatus” as used herein refers to a device for printing print data on a recording medium. For example, the image forming apparatus may form an image based on data generated from an external source such as from a computing device, mobile device (such as a smartphone), a memory device (such as a “thumb-drive” or other removeable storage media) via an electrical or data connection on a recoding medium. In some examples, the image forming apparatus may form an image based on data generated locally to the image forming apparatus, such as an integrated camera or other imaging device, a user interface, or other components to generate an image to print local to the image forming apparatus.

In some examples, one type of printing involves forming text and/or images on media that includes a thermal dye. The term “thermal dye” may refer to any compound, examples of which include dye and pigment, formed on a substrate that changes color when exposed to heat. Similarly, “thermal media” refers to the substrate that includes a layer or layers of thermal dye disposed thereon. Different thermal media may include different heat sensitive coatings of thermal dyes at a range of activation temperatures. In some examples, the longer a thermal dye layer is exposed to temperatures above its activation temperature, the higher the optical density of the thermal dye. The term “high sensitivity dye” may refer to a thermal dye that activates, or changes color, at temperatures below those of a “low sensitivity dye.” In some examples, a high sensitivity dye may activate around 70-80 degrees Celsius and a low sensitivity dye may activate around temperatures of 100 degrees Celsius. In various examples, there may be additional levels of dye sensitivities, however, in order to clarify the systems and methods described herein thermal dyes may be generally referred to as high sensitivity dyes or low sensitivity dyes in relation to one another. Furthermore, various activation temperatures may be associated with high and low sensitivity dyes in various examples.

The present devices and methods may operate on a variety of types of thermal media. In one example, a plurality of dye layers such as yellow, magenta and/or cyan dye layers are located on a substrate of the thermal media, which may be referred to as multi-dye layered media. One example multi-dye layered media is produced by Zink Holdings LLC and referred to as ZINK® media. Various other multi-dye layered media may be used by systems and methods as described herein. In another example, a single color dye layer is located on a substrate of the thermal media. The single color dye layer may be black, but may be other colors as well. In an example, the single color dye layer may have a higher thermal sensitivity than the multi-dye layered media.

Previous thermal printers may have been configured to print either single color dye layer media or multi-dye layered media, but were not configured to print both types of media. Thus, different thermal printers were used to print different thermal media. In addition, previous thermal printers did not vary the amount of power being applied based on the type of thermal media being used. Therefore, if multi-dye layered media was accidentally used in a previous thermal printer that was intended to print on single color dye layer media, the multi-dye layered media would be developed and wasted. Likewise, if single color dye media was accidentally used in a previous thermal printer that was intended to print on multi-dye layered media, the single color dye media may be over-developed and wasted. Multi-dye layered media is generally more costly than single color dye layer media, and this waste may be costly.

The present specification describes a thermal printer that is able to print both single color dye layer media or multi-dye layered media. Thus, the thermal printer described in the specification may help provide more efficient printing and a simplified printing operation as an image forming apparatus would be able to produce color printing on multi-dye layered media while also being able to produce monochromatic printing on a single color dye thermal media. Thus, one device would be able to perform both modes of printing. In addition, the present specification describes how if multi-dye layered media is accidentally used when the single color dye thermal media mode is indicated, the multi-dye layered media may not be developed since the power delivered to the printhead based on the single color dye thermal media mode may be below the power required to activate the dye layers in the multi-dye layered media. Since the multi-dye layered media may not accidentally be developed during a single color dye thermal media mode, the multi-dye layered media may be used for printing again. In addition, multi-dye layered media may also produce monochromatic printing if the source image is monochromatic. Accordingly, the image forming apparatus described in the specification may help reduce waste of thermal media used during the incorrect print mode.

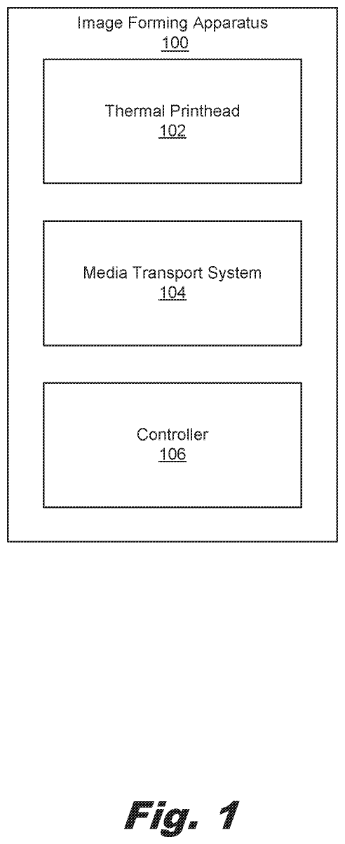

As an example, FIG. 1 is a block diagram of an image forming apparatus 100 for thermal media printing. The image forming apparatus 100 may operate on thermal media to form content thereon.

The image forming apparatus 100 includes a thermal printhead 102 that includes heating elements. The heating elements are selectively powered to form content on thermal media. For example, the heating elements may be arranged in a linear array that is perpendicular to a direction of travel of the media. At a particular point in time, each heating element may heat to different temperatures, thus heating corresponding locations of the thermal media to different temperatures. Heating the thermal media to different temperatures may cause different thermal dye layers to develop. More particularly, as different types of thermal media have thermal dye layers with different activation sensitivities, different layers are activated by different heating elements of the array of heaters.

The image forming apparatus 100 may also include a media transport system 104 to move the thermal media by the thermal printhead 102. As the thermal media moves, the different heating elements may change the amount of heat they apply to the thermal media. Again, the change in temperature alters which thermal dye layer of the thermal media is developed. Thus, as the thermal media moves, the heating elements individually heat portions of the thermal media in different patterns, which results in a pattern forming on the thermal media as printed content.

The image forming apparatus 100 may also include a controller 106 to generate print data to be printed on the thermal media. As an example, the controller 106 may include a processor and may also include and/or be coupled to a memory. This is done by powering the thermal printhead 102 based on a print mode corresponding to a type of thermal medium. The controller 106 may receive an indication of a type of print mode to be used based on the type of thermal media to be used. Examples of different types of thermal media may be multi-dye layered media or single color dye thermal media.

The controller 106 may then determine a power profile based the type of print mode to be used, and then control power to be delivered to the thermal printhead 102 based on the determined power profile. As an example, the print mode may indicate to what power and at what time different heating elements should be powered to produce the desired content. As an example, the power profile may indicate to deliver more power to the thermal printhead 102 when a multi-dye layered media print mode is indicated, and may indicate to deliver less power to the printhead 102 when a single color dye thermal media print mode is indicated. In another example, the power profile may indicate to deliver more power to the thermal printhead 102 for lesser period of time when a multi-dye layered media print mode is indicated, and may indicate to deliver less power to the thermal printhead 102 for a greater period of time when a single color dye thermal media print mode is indicated.

In some examples, the image forming apparatus 100 may be handheld. That is, the image forming apparatus 100 may be a small format image forming apparatus 100. In some examples, the image forming apparatus 100 may include a tray in which sheets of thermal media are held. In another example, the image forming apparatus 100 may include a spindle to which a roll of thermal media may be attached.

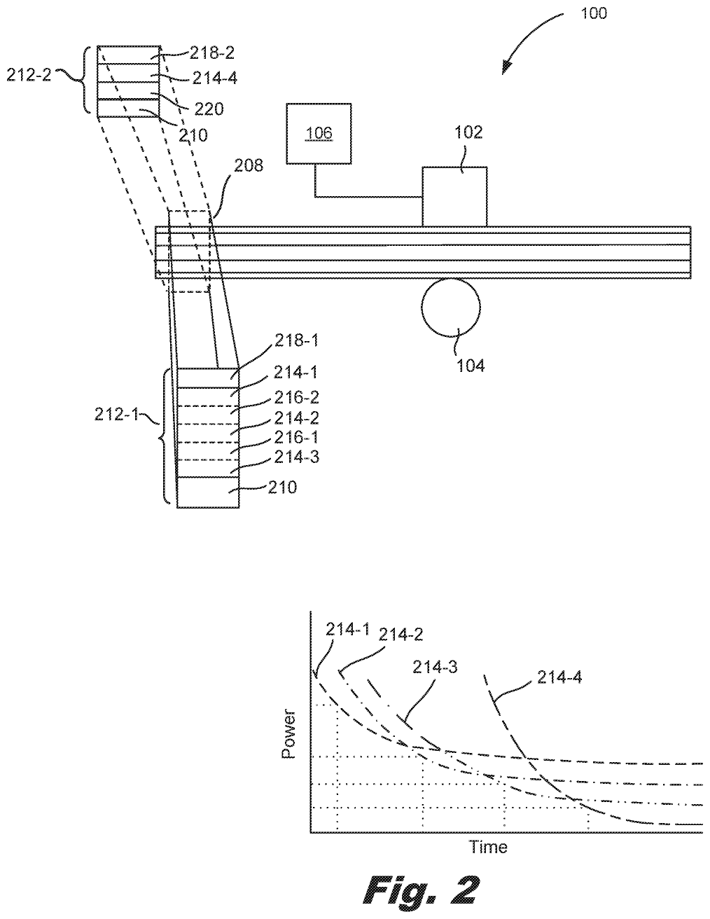

FIG. 2 depicts an image forming apparatus 100 for thermal media 208 printing, according to an example of the principles described herein. As an example, FIG. 2 shows the thermal printhead 102, media transport system 104, and controller 106.

In some examples, the media transport system 104 includes a support member to bias a top side of the thermal media 208, such as an overcoat of a thermal media, against the thermal printhead 102 such that the thermal printhead 102 contacts the thermal media 208. The biased support member helps cause the thermal media 208 to contact the thermal printhead 102 to provide high quality imaging. In an example, the thermal printhead 102 or the media transport system 104 may be adjusted to media thickness, for example via a dial or a spring force.

In an example, when the thermal media 208 is multi-dye layered media 212-1, the multiple thermal dye layers 214-1, 214-2, 214-3 may be formed on the thermal media 208, each pair of thermal dye layers 214 being separated by an insulating layer 216-1, 216-2. In this example, the different layers 214-1, 214-2, 214-3 on the first side of multi-dye layered media 212-1 may change to different colors and have different activation sensitivities.

In an example, when the thermal media 208 is a single color dye thermal media 212-2, a single thermal dye layer 214-4 may be formed on the thermal media 208. Thus, the single color dye thermal media 212-2 may be monochromatic.

The lower layers in the multi-dye layered media 212-1 may activate, or develop, at a lower temperature than higher layers. As an example, a first layer 214-1 may activate at a higher temperature than both the second layer 214-2 and the third layer 214-3, while the second layer 214-2 may activate at a higher temperature than the third layer 214-3, but at a lower temperature than the first layer 214-1. In so doing, the lower layers may be developed without developing higher layers.

As an example, a first layer 214-1 may have the lowest activation sensitivity among layers 214-1, 214-2, 214-3, 214-4, meaning it takes the highest temperature to cause a change in color. The layer 214-4 in the single color dye thermal media 212-2 may have the highest activation sensitivity among layers 214-1, 214-2, 214-3, 214-4, meaning it absorbs the lowest temperature to cause a change in color. In this example, the lower thermal dye layers 214-2, 214-3 may take longer to reach activation temperature as compared to a top thermal dye layer 214-1 because of the insulation layers 216-1, 216-2.

In an example, yellow, magenta and cyan dye layers 214-1, 214-2, 214-3, respectively are located on the multi-dye layered media 212-1 with the yellow layer 214-1 positioned closest to the thermal printhead 102 followed by the magenta layer 214-2 and the cyan layer 214-3. Between each dye layer is an insulating layer 216-1, 216-2. In an example of the multi-dye layered media 212-1, the thermal dye layers 214-1, 214-2, 214-3 may have a substrate 210 below it. The multi-dye layered media 212-1 may be coated with an overcoat 218-1 protective layer to seal the thermal media 208 and protect against damage to the media and exposed layers. In addition, the multi-dye layered media 212-1 may have an adhesive layer and a liner at the bottom.

In an example of the single color dye thermal media 212-2, a single thermal dye layer 214-4 resides and may have a basecoat 220 and a substrate 210 below it. The single color dye thermal media 212-2 may be coated with an overcoat 218-2 protective layer to seal the thermal media 208 and protect against damage to the media and exposed layers. In addition, the single color dye thermal media 212-2 may have an adhesive layer and a liner at the bottom.

As described above, the controller 106 selectively causes the powering of the individual heating elements to independently activate different dye layers 214. That is, pulse width-modulated control of the thermal printhead 102 enables activation of the different layers 214 independently. The controller 106 may adjust power to be delivered to the thermal printhead 102 using pulse width-modulation and may adjust the power to be delivered based a heating profile corresponding to a type of print mode to form an image on either the single color dye thermal media 212-2 or on the multi-dye layered media 212-1 The colored layers may start colorless but become more chromatic the longer they are exposed to temperatures above their respective activation temperatures.

As depicted in the graph of FIG. 2, each of the different layers 214 have different activation sensitivities. For example, to develop the layer 214-4 on the single color dye thermal media 212-2, the thermal printhead 102 may be operated at a first temperature for a period of time. Note that as depicted in FIG. 2, there is a temperature at which the thermal printhead 102 may operate which will develop the monochromatic layer 214-4 on the single color dye thermal media 212-2, that may not develop any of the layers 214-1, 214-2, 214-3 of the multi-dye layered media 212-1.

Similarly, to develop the cyan layer 214-3 on the multi-dye layered media 212-1, the thermal printhead 102 may be operated at a second temperature for a period of time. Note that as depicted in FIG. 2, there is a temperature at which the thermal printhead 102 may operate which will develop the third, or cyan layer 214-3 on the multi-dye layered media 212-1, that will not develop any of the above layers 214-1, 214-2.

Similarly, to develop the magenta layer 214-2 on the multi-dye layered media 212-1, the thermal printhead 102 may be operated at a third temperature for a period of time. Note that as depicted in FIG. 2, there is a temperature at which the thermal printhead 102 may operate which will develop the second, or magenta layer (214-2) on the multi-dye layered media 212-1, that will not develop any of the above layers 214-1.

Similarly, to develop the yellow layer 214-1 on the multi-dye layered media 212-1, the thermal printhead 102 may be operated at a fourth temperature for a period of time.

In addition, the longer a thermal dye layer is exposed to temperatures above its activation temperature, the higher the optical density of the thermal dye.

Accordingly, the controller 106 obtains a heating profile corresponding to a type of print mode to form an image on either the single color dye thermal media 212-2 or on the multi-dye layered media 212-1, which heating profiles indicate which heating elements should be powered to what temperatures and for how long to ensure that appropriate layers are developed and others are not.

During printing, the thermal printhead 102 activates a thermal dye layer with a higher activation sensitivity, i.e., a lower activation temperature, by exposing the thermal dye layer 214 to a lower temperature for a longer period of time as compared to a thermal dye layer with a lower activation sensitivity. That is, as depicted in FIG. 2, for thermal dye layers 214 closer to the thermal printhead 102, temperature is increased and period of exposure is decreased.

In an example, the image forming apparatus 100 may develop the layer 214-4 on the single color dye thermal media 212-2 without developing the layer(s) 214-1, 214-2, 214-3 on the multi-dye layered media 212-1, for example by operating the heating elements at a temperature higher than a threshold to develop the layer 214-4 on the single color dye thermal media 212-2, but lower than a threshold to develop the layers 214-1, 214-2, 214-3 on the multi-dye layered media 212-1.

The controller 106 receives an indication of a print mode corresponding to a type of thermal media. Some examples of the thermal media are the multi-dye layered media 212-1 and the single color dye thermal media 212-2. Thus, some examples of the print modes may be a multi-dye layered media print mode and a single color dye thermal media print mode. The controller 106 may then determine a power profile that indicates an amount of power to deliver to the thermal printhead 102 based on the indicated print mode. As an example, a lower amount of power may be delivered for the single color dye thermal media 212-2, while a larger amount of power may be delivered for multi-dye layered media 212-1. In addition, the controller may determine a length of time to deliver the power based on the indicated print mode. As an example, the multi-dye layered media 212-1 may be operated for a lesser amount of time than the single color dye thermal media 212-2.

The controller 106 then controls power to be delivered to the thermal printhead 102 according to the determined power profile. As an example, the determined profile of the single color dye thermal media print mode may indicate to deliver an amount of power for the single color dye thermal media print mode at a level high enough to activate the dye in the single color dye thermal media 212-2, but low enough to not activate any of the dye in the multi-dye layered media 212-1. Therefore, if multi-dye layered media 212-1 is accidentally used when the single color dye thermal media mode is indicated, the multi-dye layered media 212-1 may not be developed since the power delivered to the printhead 102 based on the single color dye thermal media mode may be below the power threshold to activate the yellow, magenta or cyan dye layers 214-1, 214-2, 214-3 in the multi-dye layered media 212-1. Since the multi-dye layered media 212-1 may not accidentally be developed during a single color dye thermal media mode, the multi-dye layered media 212-1 may be used for printing again. Accordingly, the image forming apparatus 100 described above may help reduce waste of thermal media used during the incorrect print mode.

The controller 106 may also determine a thermal medium speed profile that indicates a speed to transport the thermal media 208 past the thermal printhead 102 based on the indicated print mode. The controller 106 may then control a speed the thermal media 208 passes through the image forming apparatus based on the speed profile. As an example, the controller 106 may control the thermal media 208 to be transported by thermal printhead 102 at a speed lower than a threshold when a multi-dye layered media print mode is indicated, and may control the thermal media 208 to be transported by thermal printhead 102 at a speed higher than a threshold when a single color dye thermal media print mode is indicated. Thus, the thermal media 208 would be transported by the thermal printhead 102 at a slower speed when a multi-dye layered media print mode is indicated and the thermal media 208 would be transported by the thermal printhead 102 at a higher speed when a single color dye thermal media print mode is indicated. The higher the speed the thermal media is transported by the thermal printhead 102 results in reduced heating of the thermal media 208 when the thermal printhead 102 is heated at a constant power. Accordingly, since the thermal media 208 is be transported by the thermal printhead 102 at a higher speed when a single color dye thermal media print mode is indicated, the dye layers 214-1, 214-2, 214-3 in the multi-dye layered media 212-1 may not be activated if the multi-dye layered media 212-1 is accidentally used instead of a single color dye thermal media 212-2 when a thermal media transport speed corresponding to a single color dye thermal media print mode is used.

In addition, the controller 106 may control a speed the thermal media 208 passes through the image forming apparatus 100 based on the speed profile while also controlling power to be delivered to the thermal printhead 102 based on the determined power profile.

As an example, the image forming apparatus 100 may be opened up and the thermal media 208 may be placed in a tray on the interior of the image forming apparatus 100. In another example, the image forming apparatus 100 may include a spool on which a roll of thermal media 208 may be placed. In another example, the image forming apparatus 100 may include a document feeder or slot through which thermal media 208 may be fed. Any variety of thermal media 208 may be implemented in accordance with the principles described herein including rolls of media, or single sheets such as blank business cards, sticky notes, index cards, and/or photographic paper.

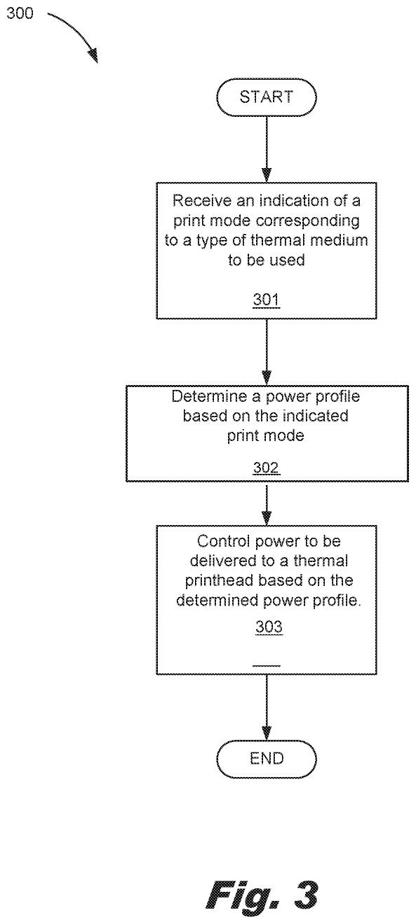

As an example, FIG. 3 is a flow chart of a method 300 performed by an image forming apparatus 100. The image forming apparatus 100 receives an indication of a print mode corresponding to a type of thermal medium. Some examples of thermal media are the multi-dye layered media 212-1 and the single color dye thermal media 212-2. Thus, some examples of the print modes may be a multi-dye layered media print mode and a single color dye thermal media print mode.

The image forming apparatus 100 then determines a power profile based on the indicated print mode and controls power to be delivered to a thermal printhead based on the determined power profile. As an example, based on a profile, a lower amount of power may be delivered for the single color dye thermal media 212-2, while a larger amount of power may be delivered for multi-dye layered media 212-1. In addition, the controller may determine a length of time to deliver power based on the indicated print mode. As an example, the multi-dye layered media 212-1 may be powered for a lesser amount of time than the single color dye thermal media 212-2.

The image forming apparatus 100 then controls the power to be delivered to the thermal printhead 102 based on the determined power profile. As an example, the obtained profile of the single color dye thermal media print mode may indicate to deliver an amount of power for the single color dye thermal media print mode at a level high enough to activate the dye in the single color dye thermal media 212-2, but low enough to not activate any of the dye in the multi-dye layered media 212-1. Therefore, if multi-dye layered media 212-1 is accidentally used when the single color dye thermal media mode is indicated, the multi-dye layered media 212-1 may not be developed since the power delivered to the printhead 102 based on the single color dye thermal media mode may be below the power threshold to activate the yellow, magenta or cyan dye layers 214-1, 214-2, 214-3 in the multi-dye layered media 212-1. Since the multi-dye layered media 212-1 may not accidentally be developed during a single color dye thermal media mode, the multi-dye layered media 212-1 may be used for printing again. Accordingly, the image forming apparatus 100 described above may help reduce waste of thermal media used during the incorrect print mode.

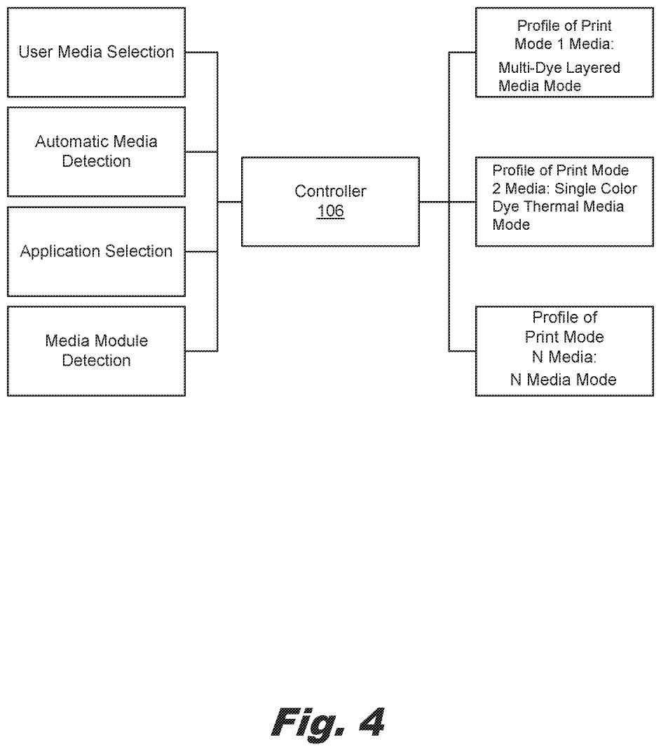

FIG. 4 is a diagram of print mode selection for thermal media 208 printing. As an example, the controller 106 may include a processor and may also include and/or be coupled to a memory. As an example, the memory may store the profiles of the different print modes. As described above, thermal printing may be performed on a variety of thermal media such as multi-dye layered media 212-1 and single color dye thermal media 212-2. Accordingly, the controller 106 may receive an indication of the type of thermal media 208 and may determine an amount of power to deliver to the thermal printhead 102 accordingly. For example, the controller 106 may determine that a first print mode, Print Mode 1, is to be executed, which Print Mode 1 corresponds to the thermal media being multi-dye layered media 212-1. The controller 106 may also determine that a second print mode, Print Mode 2, is to be executed, which Print Mode 2 corresponds to media being a single color dye thermal media 212-2. Other print modes may also be indicated to the controller 106.

As an example, Print Mode 1 includes a profile that indicates how much power to deliver to the thermal printhead. In addition, Print Mode 2 includes a profile to indicate how much power to deliver to the thermal printhead.

As an example, the profile of Print Mode 2 may indicate to deliver an amount of power at a level high enough to activate the dye in the single color dye thermal media 212-2, but low enough to not activate any of the dye in the multi-dye layered media 212-1.

The indications of the print mode may be received from a user manually inputting the thermal media type. A user may input the print mode using a portable device, such as an application, or may enter it on a display of the image forming apparatus 100. The user may also input the print mode a variety of other ways as well. Other examples of the indications include a hardware component or media module of the image forming apparatus 100 indicating the thermal media type. In yet another example, an application executing on the image forming apparatus 100 or a computing device coupled to the image forming apparatus 100 may make the determination.

In addition, the indications of the print mode may also include the controller 106 receiving an image to be printed and determining the type of print mode to be used based on the type of image received. The image may be received from a computer, a portable device, or from other recording mediums. For example, if a color image is received, the controller may determine that the multi-dye layered media 212-1 print mode is to be used. However, if a monochromatic image is received, such as a black and white image, the controller 106 may determine that the single color dye thermal media 212-2 mode is to be used.

As an example, the image forming apparatus may detect a type of thermal media is loaded in the image forming apparatus 100. The image forming apparatus 100 may detect the type of thermal media stored using a variety of ways, such as scanning a barcode located on the thermal media. The image forming apparatus 100 may also include a sensor or sensors to detect the type of thermal media that is loaded in the image forming apparatus 100. The sensor(s) may sense one or more of weight, size, light, among others. However, the sensor(s) are not limited to sensing these particular values. The controller 106 then may determine the type of thermal media based on the sensed values, and then determine a print mode based on the detected type of thermal media located in the image forming apparatus 100.

Upon receiving the detected type of thermal media, the controller 106 may then determine the detected thermal media does not correspond with the indicated print mode and indicate the type of thermal media loaded in the image forming apparatus 100 be changed or the type of print mode be changed.

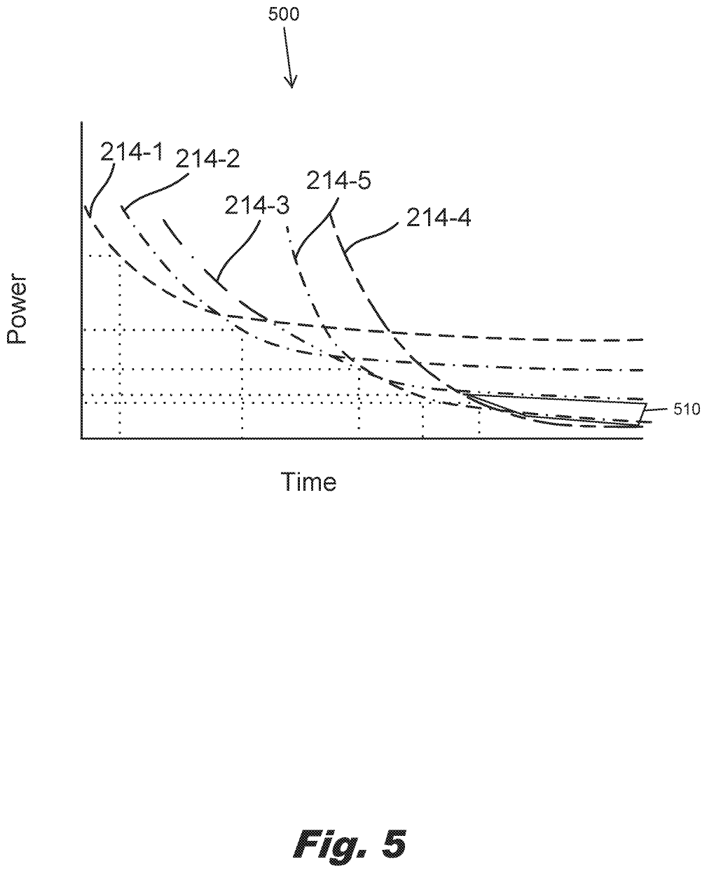

As an example, FIG. 5 illustrates an example graph 500 of activation temperatures and durations for activating thermal dyes of a thermal media 208. For example, the thermal media 208 may be developed by the image forming apparatus 100 as described above. The example graph 500 demonstrates how a multi-dye layered media 212-1 sheet is preserved when incorrectly loaded into an image forming apparatus 100 operating in a single color dye thermal media 212-2 print mode having a lower activation temperature than the multi-dye layered media 212-1. In the case that multi-dye layered media 212-1 was accidentally loaded in the image forming apparatus 100, where the print job calls for single color dye thermal media 212-2 printing, none of the yellow, magenta or cyan dye layers 214-1, 214-2, 214-3 would develop because they have not reached their respective activation temperatures. For example, the single color print mode may activate the loaded thermal media in region 510 shown in example graph 500. Accordingly, the applied power does not activate the thermal dyes also shown in graph 500. That is, the power or time used 214-5 to develop the single color dye thermal media 212-2 that was intended to be printed on, but not actually inserted, is lower than the power or time threshold to activate the colored thermal dye layers 214-1, 214-2, 214-3 such that they would not be developed and the media may be printed again.

The operating method of the image forming apparatus 100 may be embodied in the form of instructions executable by a computer or a processor or a machine-readable storage medium that stores data. The method of operating the image forming apparatus 100 may be written as computer programs and may be implemented in general-use digital computers that execute the programs using a machine-readable storage medium. The above-mentioned machine-readable storage medium may be read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, a magnetic tape, floppy disc, a magnet optical recording medium, an optical data recording medium, hard disc, solid-state disc (SSD), or any kind of device capable of storing instructions of machine-readable instructions, relevant data, data files, and data structure and capable of providing instructions or machine-readable instructions, relevant data, data files, and data structures to a processor or a computer such that the processor or computer may execute the instruction.

As an example, the image forming apparatus, method, and instructions stored on the non-transitory machine-readable storage medium may help provide more efficient printing and a simplified printing operation as an image forming apparatus would be able to produce color print on multi-dye layered media while also being able to produce monochromatic printing on a single color dye thermal media. Thus, one device would be able to perform both modes of printing. In addition, the image forming apparatus, method, and instructions stored on the non-transitory computer readable medium may waste less media, such as the more expensive multi-dye layered media, due to some media not being wasted if incorrect thermal media is used for a particular print mode.

The foregoing examples of the disclosure were described in greater detail with reference to the accompanying drawings, wherein like reference characters denote like elements. The foregoing examples are merely examples and are not to be construed as limiting the disclosure. The examples may be modified and implemented in various different forms. The disclosure can be readily applied to other types of apparatuses. Also, the description of the examples of the disclosure is intended to be illustrative, and not to limit the scope of the claims.

When it is stated in the disclosure that one element is “connected to” or “coupled to” another element, the expression encompasses not only an example of a direct connection or direct coupling, but also a connection with another element interposed therebetween. Further, when it is stated herein that one element “includes” another element, unless otherwise stated explicitly, it means that yet another element may be further included rather than being excluded.

As used in the disclosure, including in the claims, the word “or” is used in an inclusive manner. For example, “A or B” means any of the following: “A” alone, “B” alone, or both “A” and “B”.

While the disclosure has been described with reference to the accompanying drawings, it is to be understood that the scope of the disclosure is defined by the claims described hereinafter and should not be construed as being limited to the above-described examples and/or drawings. It is to be clearly understood that improvements, changes, and modifications that are obvious to those skilled in the art are also within the scope of the disclosure as defined in the claims.

What is claimed is:

1. An image forming apparatus comprising:
a thermal printhead including heating elements; and
a controller to receive an indicated print mode corresponding to a type of thermal medium to be used, determine a power profile based on the indicated print mode, and control power to be delivered to the thermal printhead based on the determined power profile.

2. The image forming apparatus of claim 1, wherein the controller is to receive an image to be printed, and determine the type of thermal medium to be used based on the received image.

3. The image forming apparatus of claim 1, wherein the controller is to adjust a duration of the power to be delivered to the thermal printhead based on the determined power profile.

4. The image forming apparatus of claim 1, wherein the image forming apparatus further includes a sensor to sense the type of thermal medium in the image forming apparatus, and
the controller is to determine the print mode based on a sensed type of thermal medium.

5. The image forming apparatus of claim 1, wherein the indicated print mode is one of a multi-dye layered media print mode or a single color dye thermal media print mode, and the single color dye thermal media print mode indicates the power profile is to power the thermal printhead higher than a first threshold to activate single color dye thermal media and lower than a second threshold to activate multi-dye layered media.

6. The image forming apparatus of claim 1, wherein the controller is to
determine whether the indicated print mode corresponds to the type of thermal medium located in the image forming apparatus; and
in response to a determination the indicated print mode does not correspond to the type of thermal medium located in the image forming apparatus, indicate the type of thermal medium in the image forming apparatus or the print mode be changed.

7. A method by an image forming apparatus, the method comprising:
receiving an indication of a print mode corresponding to a type of thermal medium;
determining a power profile based on the indicated print mode; and
controlling power to be delivered to a thermal printhead based on the determined power profile.

8. The method of claim 7, wherein the receiving the indication of the print mode includes:
receiving an image to be printed; and
determining the print mode based on the received image.

9. The method of claim 7, wherein the method further comprises:
determining a thermal medium speed profile based on the indicated print mode;
controlling a speed a thermal medium passes through the image forming apparatus based on the determined thermal medium speed profile.

10. The method of claim 7, wherein the receiving the indication of the print mode includes:
sensing the type of thermal medium in the image forming apparatus; and
determining the print mode based on the sensed type of thermal medium.

11. The method of claim 7, wherein the indicated print mode is one of a multi-dye layered media print mode or a single color dye thermal media print mode, and the single color dye thermal media print mode indicates the power profile is to power the thermal printhead higher than a first threshold to activate single color dye thermal media and lower than a second threshold to activate multi-dye layered media.

12. The method of claim 7, wherein the method further comprises:
determining whether the indicated print mode corresponds to the type of thermal medium located in the image forming apparatus; and
in response to determining the indicated print mode does not correspond to the type of thermal medium located in the image forming apparatus, indicating the type of thermal medium in the image forming apparatus or the print mode be changed.

13. A non-transitory machine-readable storage medium with instructions stored thereon that, when executed by a processor, causes the processor to:
determine an amount of power to deliver to a thermal printhead based on an indicated print mode corresponding to a type of thermal medium to be used; and
cause the determined amount of power to be delivered to the thermal printhead.

14. The non-transitory machine-readable storage medium of claim 13, wherein the instructions, when executed by the processor, further causes the processor to:
determine the indicated print mode based on a sensed type of thermal medium in an image forming apparatus or a received image.

15. The non-transitory machine-readable storage medium of claim 13, wherein the instructions, when executed by the processor, further causes the processor to:
determine whether the indicated print mode corresponds to the type of thermal medium located in an image forming apparatus; and
in response to a determination the indicated print mode does not correspond to the type of thermal medium located in the image forming apparatus, indicate the type of thermal medium in the image forming apparatus or the print mode be changed.
